(19) United States
(12) Patent Application Publication
(10) Pub. No.: US 2003/0012017 A1
(43) Pub. Date: Jan. 16, 2003

(54) Built-in modular lighting elements and strips of such elements

(75) Inventor: Fabio Reggiani, Vedano al Lambro (IT)

Correspondence Address: Shlesinger, Fitzsimmons & Shlesinger, Suite 1323, 183 East Main Street, Rochester, NY, 14604, US

(73) Assignee: Reggiani S.p.A. Illuminazione

(21) Appl. No.: 10/188,024

(22) Filed: Jun. 27, 2002

(30) Foreign Application Priority Data
Jul. 11, 2001 (IT) MI2001U 000385

(51) Int. Cl. F21S 8/04

(52) U.S. Cl. 362/148; 362/147; 362/150; 362/249; 362/364

(57) ABSTRACT

Modular lighting elements (10) are designed to be embedded in a surface so that a square front face (13) thereof appears on the surface, which front face is provided with a frame (14) at the outside of the surface itself. The elements (10) are such shaped that they are laterally coupled with each other to form strips of elements. Each element (10) comprises a pair of spring thrust elements (15) exerting pressure against the inside of the surface to keep the element in place in the housing. The two thrust elements of each pair laterally project from the corresponding lighting element close to opposite corners of said square front face. The elements (10) can have a finishing frame on some sides and fitting means on other sides to enable juxtaposition and mutual fitting of the elements, while preserving continuity and thickness of the finishing frames.

### BACKGROUND OF THE INVENTION

The present inventions relates to built-in lighting elements or spotlights and to strips of elements made therewith.

Built-in lighting elements are known in the art that are usually formed with a front face of square or circular shape, designed to appear from a hole formed in the housing surface. In the known art elements are required to be embedded one by one, each in a receiving hole of its own. This involves heavy working operations in the housing surfaces and does not enable achievement of particular configurations consisting of several lighting elements coming together to form a single assembly.

It is a general aim of the present invention to obviate the above mentioned drawbacks by providing lighting elements to be built-in which are modular and can be coupled with each other to form complex systems and lighting “strips” of varying configurations, by minimum working of the housing surface and with excellent both aesthetic and mechanical features.

### SUMMARY OF THE INVENTION

In view of the above aim, in accordance with the invention modular lighting elements have been conceived which are designed to be embedded in a surface so that a square front face thereof appears on the surface, which face is provided with a frame at the outside of the surface, the elements being such shaped that they can be laterally coupled with each other to form a strip of elements, each element comprising a pair of spring thrust elements exerting pressure against the inside of the surface to keep the element in place in the housing, the two thrust elements of each pair laterally projecting from the corresponding lighting element close to opposite corners of said square front face.

### BRIEF DESCRIPTION OF THE DRAWINGS

For better explaining the innovative principles of the present invention and the advantages it offers over the known art, a possible embodiment applying the above principles will be described hereinafter, by way of example, with the aid of the accompanying drawings. In the drawings:

FIG. 1 is a diagrammatic side view of a lighting element in accordance with the invention, generally sectioned along line I-I in FIG. 2;

FIG. 2 is a plan view taken along line II-II in FIG. 1;

FIGS. 3 and 4 are front views of two possible exemplary arrangements to be obtained with the lighting elements in accordance with the invention.

### DETAILED DESCRIPTION OF THE INVENTION

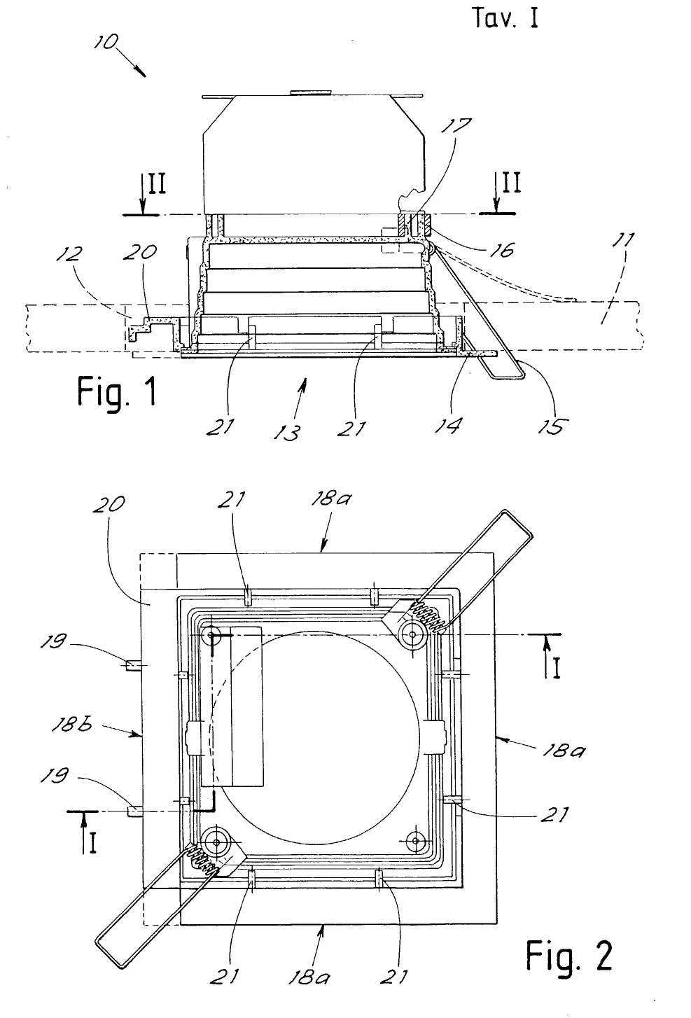

With reference to the drawings, a first modular lighting element (generally identified by 10) made in accordance with the invention is designed to be embedded in an opening or hole 12 formed in a surface 11 (shown in chain line in FIG. 1) to appear from the surface by a square front face 13 thereof provided with a frame 14 on the outside of the surface.

As shown in FIG. 1 and better in FIG. 2, element 10 comprises a pair of spring thrust elements 15 exerting pressure against the inside of the surface (as seen in chain line in FIG. 1) to keep the element in place in the housing. The two thrust elements 15 project from the lighting element close to opposite corners of the square front face. In particular, the thrust elements 15 diagonally project from said opposite corners. Advantageously, as viewed from the figures, the thrust elements comprise a wire spring 15 with a fastening end which is engaged in a support 16 fastened to the lighting element. Fastening may take place by fitting of the support element on a threaded fastening shank 17 between a front portion and a rear portion of the spotlight 10.

Support elements for the spring may be provided and they are disposed at all of the four corners. The springs will then be mounted to two opposite corners alone. Thus the springs are removable and shiftable between the corners. Elements 10 are such shaped that they can be laterally coupled with each other to form a strip of elements, as clarified in the following.

Elements 10 may comprise a finishing frame on three sides 18a of the front face and means 19 for fitting in the other elements on the fourth side 18b, as shown in solid line in FIGS. 1 and 2, or they may have a finishing frame 14 on all of the four sides of the front face (as shown in chain line still in FIGS. 1 and 2).

Advantageously, the elements with a finishing frame on three sides have an abutment frame 20 on the fourth side 18b which is designed to rest at the rear on the finishing frame of another element. Teeth 19 project from the abutment frame for fitting into corresponding seats 21 in the other elements.

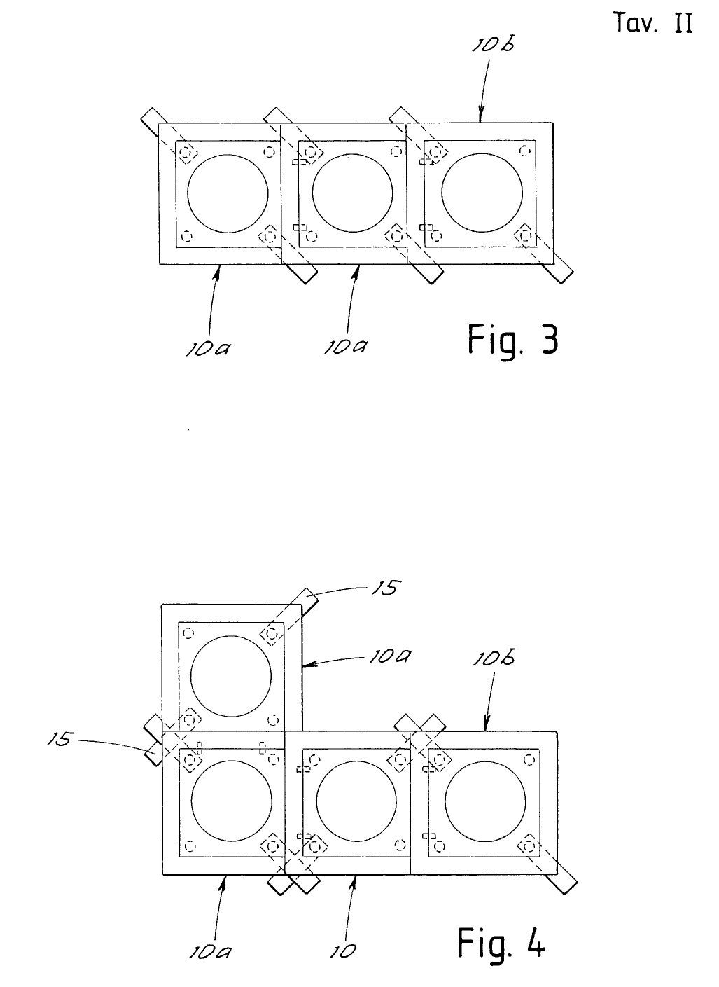

Possible combinations of lighting elements in accordance with the invention are shown in FIGS. 3 and 4.

For instance, shown in FIG. 3 is a rectilinear strip made up of a sequence of elements 10a (two elements in this particular case) provided with a frame on three sides thereof and sequentially disposed in juxtaposed relationship with each other. On the fourth side of the last one of said elements 10a one of the lighting elements 10b with a finishing frame on four sides is juxtaposed. In this way closure of the complete frame of the assembly is achieved.

It will be recognised that the frame around each lamp keeps a uniform thickness so that the lighting element assembly appears as a unitary piece by sight.

Shown in FIG. 4 is an alternative embodiment of an assembly, consisting of an angle-shaped strip obtained by suitably disposing elements 10a.

As can be seen from the figures, the fastening spring elements always enable the respective lighting element to be fixed on at least two opposite points, thereby ensuring the assembly stability.

At this point it is apparent that the intended aims have been achieved by providing modular elements enabling the most varied mutual combinations.

From the preceding explanation it appears obvious that the lighting elements in accordance with the invention can be disposed so as to form strips with different extension and/or configuration, while always keeping the continuity and thickness features of the finishing frame and the mechanical stability features of the assembly. Optionally, removal or displacement of springs may be carried out.

Obviously, the above description of an embodiment applying the innovative principles of the present invention is given by way of example only and therefore must not be considered as a limitation of the scope of the invention as herein claimed. For instance, the exact aesthetic appearance or sizes of the different parts can vary depending on specific requirements. Elements having a different number or position of the finishing frames can also be envisaged.

What is claimed is:

1. Modular lighting elements designed to be embedded in a surface so that a square front face thereof appears on the surface, which face is provided with a frame at the outside of the surface, the elements being such shaped that they can be laterally coupled with each other to form a strip of elements, each element comprising a pair of spring thrust elements exerting pressure against the inside of the surface to keep the element in place in the housing, the two thrust elements of each pair laterally projecting from the corresponding lighting element close to opposite corners of said square front face.

2. Elements as claimed in claim 1, characterised in that the thrust elements project from said opposite corners in a diagonal direction.

3. Elements as claimed in claim 1, characterised in that the thrust elements are removable and shiftable between the corners.

4. Elements as claimed in claim 1, characterised in that they have a finishing frame on some sides and fitting means on others to enable juxtaposition and mutual fitting of the elements, while preserving the continuity and thickness of the finishing frames.

5. Elements as claimed in claim 1, characterised in that some of them have a finishing frame on three sides of the front face and means for fitting in other elements on the fourth side, whereas other elements have a finishing frame on four sides of the front face.

6. Elements as claimed in claim 4, characterised in that the elements with a finishing frame on three sides, on the fourth side have an abutment frame designed to rest at the rear on the finishing frame of another element, teeth emerging from said abutment frame for fitting into corresponding seats in the other elements to accomplish said fitting means.

7. Elements as claimed in claim 1, characterised in that the thrust elements comprise a wire spring having an end for fastening to the element, which end is engaged in a support to be fixed to said element.

8. Lighting strips formed with sequences of elements in accordance with claim 1.

9. Lighting strips as claimed in claim 8, comprising series of elements provided with a frame on three sides, which are sequentially disposed in juxtaposed relationship with each other, on the fourth side of the last of them being juxtaposed one of said lighting elements with a finishing frame on four sides.
